(19) United States
(12) Patent Application Publication
(10) Pub. No.: US 2016/0260524 A1
(43) Pub. Date: Sep. 8, 2016

(54) CABLES FORMED FROM HALOGEN-FREE COMPOSITIONS HAVING FIRE RETARDANT PROPERTIES

(71) Applicant: GENERAL CABLE TECHNOLOGIES CORPORATION, Highland Heights, KY (US)

(72) Inventors: Timothy John Clancy, Carmel, IN (US); Elliot Byunghwa Lee, Carmel, IN (US); Jon Michael Malinoski, Zionsville, IN (US); Srinivas Siripurapu, Carmel, IN (US)

(21) Appl. No.: 15/059,050

(22) Filed: Mar. 2, 2016

Related U.S. Application Data
(60) Provisional application No. 62/127,538, filed on Mar. 3, 2015.

(51) Int. Cl. H01B 7/295; H01B 3/28; H01B 3/00; C09D 123/08; C08K 3/22

(52) U.S. Cl. CPC H01B 7/295; C09D 123/0853; C08K 3/22; C08K 3/2279; H01B 3/004; H01B 3/28; C08K 2003/2224; C08K 2003/2227

(57) ABSTRACT

Cables including a fire-retardant composition are disclosed. The fire-retardant compositions include an oxygen-containing base polymer, a primary filler, and an antimony-containing secondary filler. The primary filler can be a metal hydroxide. The fire-retardant composition can be halogen-free and exhibit an elongation at break of about 150% or more. The cable passes the UL 1581 VW-1 flame.

### REFERENCE TO RELATED APPLICATIONS

The present application claims the priority of U.S. Provisional Application Ser. No. 62/127,538, entitled CABLES FORMED FROM HALOGEN-FREE COMPOSITIONS HAVING FIRE RETARDANT PROPERTIES, filed Mar. 3, 2015, and hereby incorporates the same application herein.

### TECHNICAL FIELD

The present disclosure generally relates to fire-retardant compositions that are halogen-free, and more particularly, the use of such fire-retardant compositions in insulation or jacket layers of power cables.

### BACKGROUND

Certain cabling applications can require the use of cables that are certified to pass specific qualifications such as fire resistance and wet electrical performance qualification standards. Traditionally, such qualifications have been achieved through the inclusion of halogenated components in the insulation or jacket layers of a power cable. However, such halogenated components suffer from a number of undesirable attributes including high cost, difficulty in simultaneously achieving multiple properties, and toxicity when burned. It would, therefore, be desirable to produce fire-retardant cable compositions that can enable cables to pass fire resistance and wet electrical performance qualification standards without the inclusion of halogenated materials.

### SUMMARY

In accordance with one example, a cable includes one or more conductors and a fire-retardant composition surrounding the one or more conductors. The fire-retardant composition includes about 100 parts, by weight, of an oxygen-containing base polymer; from about 80 parts to about 175 parts, by weight, of a primary filler; and from about 5 parts to about 20 parts, by weight, of a secondary filler. The primary filler includes a metal hydroxide. The secondary filler includes an antimony compound. The fire-retardant composition is substantially halogen-free and exhibits an elongation at break of about 150% or more. The cable passes the Underwriter's Laboratories (“UL”) 1581 VW-1 flame test.

In accordance with another example, a cable includes one or more conductors and a fire-retardant composition surrounding the one or more conductors. The fire-retardant composition includes about 100 parts, by weight, of an oxygen-containing base polymer; from about 80 parts to about 175 parts, by weight, of a primary filler; and from about 5 parts to about 20 parts, by weight, of a secondary filler. The primary filler includes a metal hydroxide. The secondary filler includes an antimony compound. The fire-retardant composition is substantially halogen-free and exhibits an elongation at break of about 150% or more. The cable passes the Underwriter's Laboratories (“UL”) 1581 VW-1 flame test and passes the Long Term Insulation Resistance (“LTIR”) requirements at 90° C. in accordance to UL 44.

In accordance with another example, a cable includes one or more conductors, an inner layer surrounding the one or more conductors, and a fire-retardant composition surrounding the inner layer. The fire-retardant composition includes about 100 parts, by weight, of an oxygen-containing base polymer; from about 80 parts to about 175 parts, by weight, of a primary filler; and from about 5 parts to about 20 parts, by weight, of a secondary filler. The primary filler includes a metal hydroxide. The secondary filler includes an antimony compound. The fire-retardant composition is substantially halogen-free and exhibits an elongation at break of about 150% or more. The inner layer includes a halogen-free composition. The halogen-free composition includes one or more of a polyolefin and a filled ethylene propylene rubber. The cable passes the Underwriter's Laboratories (“UL”) 1581 VW-1 flame test, the Long Term Insulation Resistance (“LTIR”) requirements at 90° C. in accordance to UL 44, and the European Committee for Electrotechnical Standardization (“CENELEC”) EN 50618.

### BRIEF DESCRIPTION OF THE DRAWINGS

FIG. 1 depicts a cross-sectional view of a single-core cable having an insulation layer formed from a fire-retardant composition according to one embodiment.

FIG. 2 depicts a cross-sectional view of a single-core cable having an insulation layer and a jacket layer according to one embodiment.

FIG. 3 depicts a cross-sectional view of a multi-core cable having a plurality of insulated conductors surrounded by a jacket layer according to one embodiment.

### DETAILED DESCRIPTION

Fire-retardant compositions can generally be useful in the formation of one, or more, layers in a cable such as, for example, a cable's insulation and jacket layers. Insulation and jacket layers formed with such compositions can allow for the construction of power cables that can meet certain fire resistance qualifications, such as the Underwriter Laboratory (“UL”) 1581 VW-1 flame test. The use of a fire-retardant composition in insulation and/or jacket layers can also permit a cable (e.g., a power cable) to meet, or pass, other physical properties and qualification tests. For example, in certain embodiments, cables including a fire-retardant composition can meet the Long Term Insulation Resistance (“LTIR”) requirements at 90° C. of UL 44.Fire-retardant compositions as disclosed herein can have a tensile strength of about 1,800 pounds per square inch (“psi”) or more and can have an elongation at break of 150% or more.

Fire-retardant compositions exhibiting such properties can include an oxygen-containing base polymer, a primary filler, and a secondary filler. As will be appreciated, additional components can also be added to certain fire-retardant compositions.

In certain embodiments, an oxygen-containing base polymer suitable for a fire-retardant composition can include certain oxygen-containing polyolefins such as, for example, ethylene vinyl acetate (“EVA”), ethylene acrylic acid, ethylene methyl acrylate, ethylene ethyl acrylate, ethylene butyl acrylate copolymers, and combinations thereof. In certain embodiments, the oxygen-containing polyolefin can be selected from ethylene vinyl acetate copolymers having varying quantities of vinyl acetate. For example, vinyl acetate can constitute from about 12% to about 40%, or more of a suitable ethylene vinyl acetate copolymer. In certain embodiments, vinyl acetate can constitute about 18% of a suitable EVA copolymer; in certain embodiments, vinyl acetate can constitute about 28% of a suitable EVA copolymer; and in certain embodiments, vinyl acetate can constitute about 40% of a suitable EVA copolymer.

As can be appreciated, a blend of several EVA copolymers having varying vinyl acetate quantities can also be utilized as an oxygen-containing base polymer. For example, a blend of about 90 parts EVA formed of 28% vinyl acetate can be blended with about 10 parts EVA formed of 40% vinyl acetate. In certain embodiments, 50% or more of a blend can be EVA formed of 28% vinyl acetate, in certain embodiments, 75% or more of a blend can be EVA formed of 28% vinyl acetate, and in certain embodiments, 90% or more of a blend can be EVA formed of 28% vinyl acetate. As can be appreciated however, non-blended EVA, such as, for example, an unblended EVA formed of 28% vinyl acetate can also be used as the sole oxygen-containing polyolefin. In certain embodiments, the oxygen-containing base polymer can be included in a fire-retardant composition at about 100 parts, by weight, of a fire-retardant composition.

The primary filler of a fire-retardant composition can be an inorganic flame retardant such as, for example, a suitable metal hydroxide, according to certain embodiments. Specific examples of suitable metal hydroxides include, without limitation, magnesium hydroxide, aluminum hydroxide, and combinations thereof. In certain embodiments, only one of either a magnesium hydroxide or aluminum hydroxide can be selected as the primary filler. For example, in certain embodiments, magnesium hydroxide can constitute the primary filler. As can be appreciated, the primary filler can have a variety of additional qualities such as, for example, a low ionic content. Additionally, in certain embodiments, the average particle size of the primary filler can vary from about 0.5 micron to about 3 microns. The primary filler can be included at about 80 parts to about 200 parts, by weight, of the fire-retardant composition in certain embodiments; at about 100 to about 175 parts, by weight, of the fire-retardant composition in certain embodiments; at about 140 parts to about 175 parts, by weight, of the fire-retardant composition in certain embodiments; and at about 160 parts to about 170 parts, by weight, of the fire-retardant composition in certain embodiments.

In certain embodiments, a primary filler can additionally be pre-treated with a surface treatment agent. Pre-treatment of a primary filler with a surface treatment agent, such as, for example, a silane coupling agent, can improve the processability and properties of the primary filler by improving adhesion and cross-linkability of the primary filler. Suitable surface treatment agents can include one, or more, of a monomeric vinyl silane, an oligomeric vinyl silane, a polymeric vinyl silane, and an organosilane compound. Examples of suitable organosilane compounds can include γ-methacryloxypropyltrimethoxysilane, methyltriethoxysilane, methyltris(2-methoxyethoxy)silane, dimethyldiethoxysilane, vinyltris(2-methoxyethoxy)silane, vinyltrimethoxysilane, vinyltriethoxysilane, octyltriethoxysilane, isobutyltriethoxysilane, isobutyltrimethoxysilane, propyltriethoxysilane, and mixtures or polymers thereof. In certain embodiments, the surface treatment agent can also be dispersed in a wax.

Alternatively, or in addition to pre-treatment of the primary filler with a surface treatment agent, a suitable surface treatment agent can be individually included in a fire-retardant composition. In certain embodiments, a surface treatment agent can be included in such compositions at about 0.5 part to about 15 parts by weight; and in certain embodiments, from about 4 parts to about 10 parts by weight. In certain embodiments, a suitable surface treatment agent can be selected from the surface treatment agents suitable for pre-treatment of a primary filler.

In certain embodiments, suitable secondary fillers for a fire-retardant composition can include additional flame retardant compounds or synergistic fire retardant compounds. For example, a secondary filler can advantageously be an antimony compound that can act as a flame retardant and can also provide a synergistic improvement to the flame retardancy properties of the primary filler. Examples of such suitable antimony compounds can include antimony trioxide, related derivative components, and combinations thereof. As can be appreciated, an antimony compound can, in the presence of the oxygen-containing base polymer and a primary filler, operate as a flame retardant without the inclusion of a halogenated compound in the fire-retardant composition. As can be further appreciated however, inclusion of large amounts of antimony, such as, about 30 parts or more of antimony oxide, can lead to fire-retardant compositions that produce large volumes of smoke when burned. A secondary filler can be included in a fire-retardant composition at about 1 part to about 30 parts, by weight, of the fire-retardant composition in certain embodiments, at about 5 parts to about 20 parts, by weight, of the fire-retardant composition in certain embodiments, and at about 10 parts to about 15 parts, by weight, of the fire-retardant composition in certain embodiments.

As can be appreciated, certain fire-retardant compositions described herein can include additional components. For example, certain fire-retardant compositions can include one, or more, of a secondary polymer or a synergistic fire retardant filler.

According to certain embodiments, a suitable secondary polymer for a fire-retardant composition can include a butadiene-styrene copolymer such as, for example, butadiene-styrene copolymers having a styrene content of about 20% to about 30% by weight. In certain embodiments, the butadiene-styrene copolymer can be arranged in a block copolymer arrangement and, in other certain embodiments, the butadiene-styrene can have a random copolymer arrangement. According to certain embodiments, butadiene-styrene copolymers can be included in a fire-retardant composition at about 3 parts to about 10 parts, by weight, of the fire-retardant composition.

A variety of suitable synergistic fire retardant fillers can be included in a fire-retardant composition according to certain embodiments. For example, one or more, zinc compounds, hydrated structured silicates, synthetic anionic hydrotalcite, clay minerals, talc, mica, kaolin, zeolites, expandable graphites, melamine compounds, phosphorus compounds, boron compounds, or silicone compounds can be included in a fire-retardant composition as a synergistic fire-retardant filler. Illustrative examples of suitable zinc compounds that can function as a synergistic fire-retardant filler can include zinc borate, zinc stannate, basic zinc molybdate, zinc calcium molybdate, zinc oxide, zinc sulfide, and combinations thereof. Suitable melamine compounds that can function as a synergistic fire retardant filler can include melamine, melamine derivatives, melamine homologues, and combinations thereof. A non-exhaustive list of suitable phosphorus compounds that can function as synergistic fire-retardant fillers can include organophosphates such as triphenyl phosphate (“TPP”), resorcinol bis(diphenylphosphate) (“RDP”), bisphenol A diphenyl phosphate (“BADP”), and tricresylphosphate (“TCP”); phosphonates including dimethyl methylphosphonate (“DMMP”); phosphinates such as aluminum diethyl phosphinate, and combinations thereof. Likewise, non-limiting examples of suitable boron compounds that can be used as a synergistic fire-retardant filler can include boric acid, zinc borate, melamine triborate, and combinations thereof. A non-limiting example of a suitable silicone compound for a synergistic fire-retardant filler is polydimethyl siloxane. As can be appreciated, when included together, certain boron compounds and silicone compounds can cooperate together to form a particularly effective synergistic fire-retardant filler and can be included together as such in certain embodiments. As can be further appreciated, certain synergistic fire-retardant fillers, such as clay minerals, talc, mica, kaolin, and zeolite, can also be included as nano-sized particles. The synergistic fire retardant filler can, in combination with the primary filler or a secondary filler, improve the fire retardancy of a fire-retardant composition. According to certain embodiments, a synergistic fire retardant filler can be included from about 3 parts to about 25 parts, by weight; in certain embodiments from about 5 parts to about 20 parts, by weight; and in certain embodiments, from about 5 parts to about 10 parts, by weight.

As can be appreciated however, a synergistic fire retardant filler can be included at different amounts depending on the synergistic components selected. For example, relatively less zinc borate can be included in a fire-retardant composition while achieving the same fire retardancy synergy as a clay mineral (e.g., about 5 parts of zinc borate can be used in certain embodiments in place of about 10 parts of a clay mineral).

According to certain embodiments, still other optional components can be included in a fire-retardant composition. For example, certain fire-retardant composition can further include one or more of an antioxidant, a processing aid, a cross-linking agent, or a colorant.

According to certain embodiments, suitable antioxidants for inclusion in a fire-retardant compositions can include, for example, amine-antioxidants, such as 4,4′-dioctyl diphenylamine, N,N′-diphenyl-p-phenylenediamine, and polymers of 2,2,4-trimethyl-1,2-dihydroquinoline; phenolic antioxidants, such as thiodiethylene bis [3-(3,5-di-tert-butyl-4-hydroxyphenyl)propionate], 4,4′-thiobis(2-tert-butyl-5-methylphenol), 2,2′-thiobis(4-methyl-6-tert-butyl-phenol), benzenepropanoic acid, 3,5-bis(1,1-dimethylethyl)4-hydroxy benzenepropanoic acid, 3,5-bis(1,1-dimethylethyl)-4-hydroxy-C13-15 branched and linear alkyl esters, 3,5-di-tert-butyl-4hydroxyhydrocinnamic acid C7-9-branched alkyl ester, 2,4-dimethyl-6-t-butylphenol tetrakis{methylene-3-(3′,5′-ditert-butyl-4′-hydroxyphenol)propionate}methane or tetrakis {methylene3-(3′,5′-ditert-butyl-4′-hydrocinnamate}methane, 1,1,3tris(2-methyl-4-hydroxyl-5-butylphenyl)butane, 2,5,di t-amyl hydroqunone, 1,3,5-tri methyl2,4,6tris(3,5ditertbutyl-4-hydroxybenzyl)benzene, 1,3,5tris(3,5di-tert-butyl-4-hydroxybenzyl)isocyanurate, 2,2-methylene-bis-(4-methyl-6-tert butyl-phenol), 6,6′-di-tert-butyl-2,2′-thiodi-p-cresol or 2,2′-thiobis(4-methyl-6-tert-butylphenol), 2,2-ethylenebis(4,6-di-t-butylphenol), triethyleneglycol bis{3-(3-t-butyl-4-hydroxy-5methylphenyl)propionate}, 1,3,5-tris(4tert-butyl-3-hydroxy-2,6-dimethylbenzyl)-1,3,5-triazine-2,4,6-(1H,3H,5H)trione, 2,2-methylenebis{6-(1-methylcyclohexyl)-p-cresol}; sterically hindered phenolic antioxidants such as pentaerythritol tetrakis(3-(3,5-di-tert-butyl-4-hydroxyphenyl)propionate); hydrolytically stable phosphite antioxidants such as tris(2,4-ditert-butylphenyl)phosphite; toluimidazole, and/or sulfur antioxidants, such as bis(2-methyl-4-(3-n-alkylthiopropionyloxy)-5-t-butylphenyl)sulfide, 2-mercaptobenzimidazole and its zinc salts, pentaerythritol-tetrakis(3-lauryl-thiopropionate), and combinations thereof. Antioxidants can be included in fire-retardant compositions at concentrations from about 0 parts to about 7 parts, by weight, of the fire-retardant composition in certain embodiments; from about 1 part to about 5 parts, by weight, in certain embodiments; and from about 1 part to about 3 parts, by weight, in certain embodiments. As can be appreciated, it can be advantageous in certain embodiments to use a blend of multiple antioxidants such as, for example, a blend of toluimidazole and a second antioxidant.

A processing aid can be included to improve the processability of a fire-retardant composition by forming a microscopic dispersed phase within a polymer carrier. During processing, the applied shear can separate the processing aid (e.g., processing oil) phase from the carrier polymer phase. The processing aid can then migrate to the die wall to gradually form a continuous coating layer to reduce the backpressure of the extruder and reduce friction during extrusion. The processing oil can generally be a lubricant, such as ultra-low molecular weight polyethylene (e.g., polyethylene wax), stearic acid, silicones, anti-static amines, organic amities, ethanolamides, mono- and di-glyceride fatty amines, ethoxylated fatty amines, fatty acids, zinc stearate, stearic acids, palmitic acids, calcium stearate, zinc sulfate, oligomeric olefin oil, or combinations thereof. In certain embodiments, a lubricant can be included from about 1 part to about 3 parts, by weight, of the composition. In certain embodiments, a fire-retardant composition can alternatively be substantially free of any lubricant or processing oil. As used herein, “substantially free” can mean that the component is not intentionally added to the fire-retardant composition, or alternatively, that the component is not detectable with current analytical methods.

In certain embodiments, a processing oil can alternatively be a blend of fatty acids, such as the commercially available products: Struktol® produced by Struktol Co. (Stow, Ohio), Akulon® Ultraflow produced by DSM N.V. (Birmingham, Mich.), MoldWiz® produced by Axel Plastics Research Laboratories (Woodside, N.Y.), and Aflux® produced by RheinChemie (Chardon, Ohio).

In certain embodiments, a fire-retardant composition can be partially, or fully, cross-linked through inclusion, or use of, a suitable cross-linking agent or method to form a thermoset composition. Non-limiting examples of suitable classes of cross-linking agents include peroxide cross-linking agents such as, for example, α,α′-bis(tert-butylperoxy) disopropylbenzene, di(tert-butylperoxyisopropyl)benzene, dicumyl peroxide, and tert-butylcumyl peroxide. Blends of multiple peroxide cross-linking agents can also be used, such as for example, a blend of 1,1-dimethylethyl 1-methyl-1-phenylethyl peroxide, bis(1-methyl-1-phenylethyl) peroxide, and [1,3 (or 1,4)-phenylenebis(1-methylethylidene)] bis(1,1-dimethylethyl) peroxide. However, it will be appreciated that other suitable cross-linking agents or methods can also be utilized to cross-link the fire-retardant composition including, for example, radiation cross-linking, heat cross-linking, electron-beam irradiation, addition cross-linking, platinum cured cross-linking, and silane cross-linking agents. A fire-retardant composition can include about 1 part to about 4 parts, by weight, of a peroxide cross-linking agent in certain embodiments, and from about 1 part to about 3 parts, by weight, of a peroxide cross-linking agent in certain embodiments.

According to certain embodiments, a colorant can also be added to a fire-retardant composition. Suitable colorants can include carbon black, cadmium red, iron blue, or a combination thereof. As can be appreciated however, the thermal properties of certain carbon blacks, such as furnace carbon black or a blend of various carbon blacks, may further enhance the fire retardancy properties of certain fire-retardant compositions. In certain embodiments, the colorant can be included from about 3 parts to about 7 parts, by weight of the fire retardant composition.

Details of additional components suitable for inclusion in a fire-retardant composition are further disclosed in U.S. Pre-Grant Publication No. 2014/0166338 which is hereby incorporated by reference.

In certain embodiments, a fire-retardant composition can include substantially no oxygen-free polyolefins such as polyethylene homopolymer, maleic anhydride, grafted polyethylene, ethylene-butene copolymer, or ethylene-octene copolymer. However, in certain embodiments, a relatively small amount of oxygen-free polyolefins, such as, for example, about 10 parts or less, of oxygen-free polyolefins can be present in a fire-retardant composition. Such quantities can be present, for example, when ultra-low molecular weight polyethylene or olefinic oligomer is used as a lubricant.

As can be appreciated, the fire-retardant compositions disclosed herein can be substantially free of dangerous compounds such as lead and halogens while retaining excellent physical properties and fire retardant properties. For example, a halogen-free composition can have an elongation at break when measured in accordance with ASTM D412 (2010) using molded plaques of about 150% or more, in certain embodiments, about 180% or more, and in certain embodiments, about 200% or more. Mechanically, plaques made from such fire-retardant compositions can also have a tensile strength of about 1,800 pounds per square inch (“psi”) or more according to certain embodiments; and in certain embodiments about 2,000 psi or more. Power cables containing one, or more, insulation layers and jacket layers produced from such fire-retardant compositions can additionally pass both the UL 1581 VW-1 flame test and the LTIR requirements at 90° C. of UL 44.

Fire retardant compositions can be prepared by blending the components/ingredients in conventional masticating equipment, for example, a rubber mill, brabender mixer, banbury mixer, Buss-Ko kneader, farrel continuous mixer, or twin screw continuous mixer. The components can be premixed before addition to the polyolefin base polymer (e.g., polyolefin). The mixing time can be selected to ensure a homogenous mixture.

Fire-retardant compositions having good physical, electrical, and mechanical properties can be well suited for use in a variety of applications. For example, the halogen-free nature of certain power cables formed with the fire-retardant compositions disclosed herein can be particularly suited for plenum applications where traditional fire retardant cables would emit toxic halogenated gases upon exposure to fire.

Fire-retardant compositions described herein can be applied to a cable using an extrusion method. In a typical extrusion method, an optionally heated conductor can be pulled through a heated extrusion die, such as a cross-head die, to apply a layer of melted fire-retardant composition onto the conductor. Upon exiting the die, if the composition is adapted as a thermoset composition, the conducting core with the applied fire-retardant composition layer may be passed through a heated vulcanizing section, or continuous vulcanizing section and then a cooling section, such as an elongated cooling bath, to cool. Multiple layers of the fire-retardant composition can be applied through consecutive extrusion steps in which an additional layer is added in each step. Alternatively, with the proper type of die, multiple layers of the composition can be applied simultaneously. As can be appreciated, a fire-retardant composition as disclosed herein can also be applied over one or more previously-applied layers. For example, a fire-retardant composition can be applied as an outer layer in certain embodiments and can surround an inner insulation layer.

As can be appreciated, power cables can be formed in a variety of configurations including as single-core cables, multi-core cables, tray cables, inter-locked armored cables, solar cables, and continuously corrugated welded (“CCW”) cable constructions. The conductors in such power cables can be surrounded by one or more insulation layers and/or jacket layers formed of the fire-retardant compositions disclosed herein.

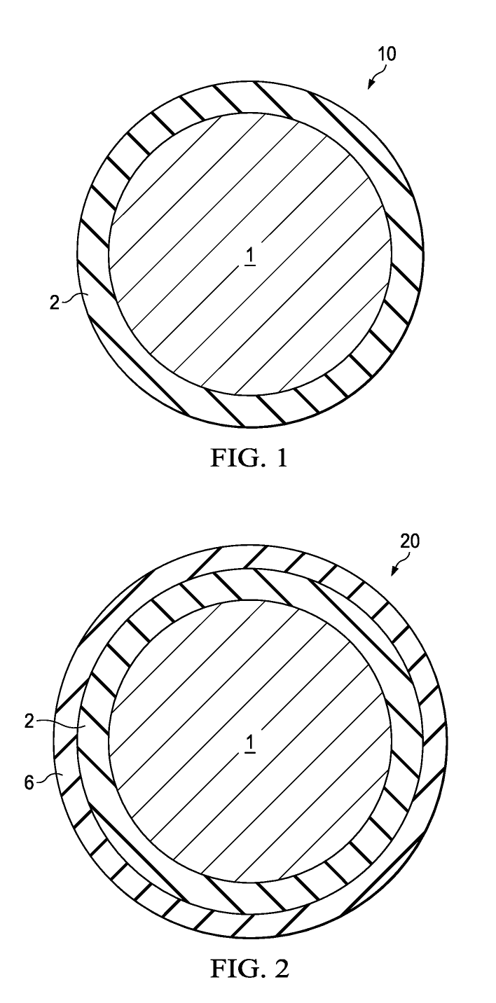

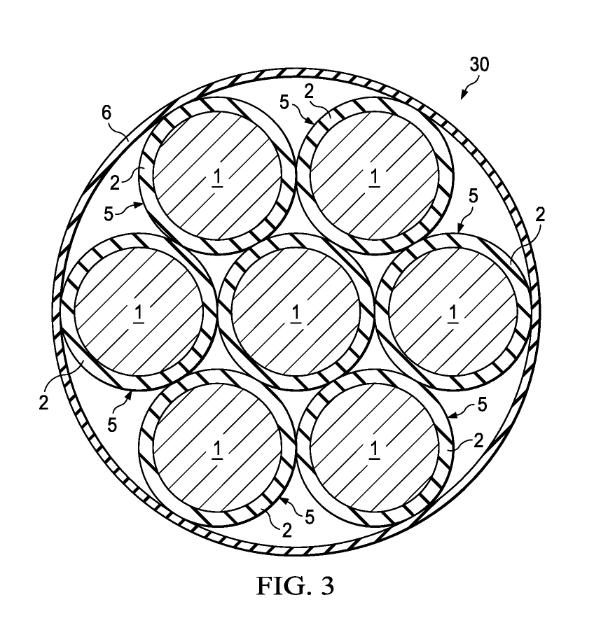

Several illustrative examples of cables are depicted in FIGS. 1 to 3. For example, a single-core cable 10 is depicted in FIG. 1 and includes a conductor 1 and an insulation layer 2. The insulation layer 2 can be formed from a fire-retardant composition as disclosed herein. As will be appreciated however, certain cables can also include a jacket layer 6 as depicted in FIGS. 2 and 3. For example, FIG. 2 depicts a single-core cable 20 that is substantially similar to the cable depicted in FIG. 1 but which further includes a jacket layer 6 surrounding the conductor 1 and insulation layer 2. Similarly, FIG. 3 depicts a multi-conductor cable 30 that includes a plurality of individually insulated conductors 5 that are collectively surrounded by a jacket layer 6. Each of the insulated conductors 5 can be similar to a single-core conductor depicted in FIG. 1 and can include a conductor 1 and an insulation layer 2. As depicted in FIGS. 2 and 3, either, or both, of the insulation layer 2 and the jacket layer 6 can be formed from a fire-retardant composition as disclosed herein. The cables depicted in FIGS. 1 to 3 can each respectively pass the UL 1581 VW-1 flame test and/or pass the LTIR requirements at 90° C. of UL 44.

The conductor, or conductive element, of a power cable, can generally include any suitable electrically conducting material. For example, a generally electrically conductive metal such as, for example, copper, aluminum, a copper alloy, an aluminum alloy (e.g. aluminum-zirconium alloy), or any other conductive metal can serve as the conductive material. As will be appreciated, the conductor can be solid, or can be twisted and braided from a plurality of smaller conductors. The conductor can be sized for specific purposes. For example, a conductor can range from a 1 kcmil conductor to a 1,500 kcmil conductor in certain embodiments, a 4 kcmil conductor to a 1,000 kcmil conductor in certain embodiments, a 50 kcmil conductor to a 500 kcmil conductor in certain embodiments, or a 100 kcmil conductor to a 500 kcmil conductor in certain embodiments. The voltage class of a power cable including such conductors can also be selected. For example, a power cable including a 1 kcmil conductor to a 1,500 kcmil conductor and an insulating layer formed from a suitable thermoset composition can have a voltage class ranging from about 1 kV to about 150 kV in certain embodiments, or a voltage class ranging from about 2 kV to about 65 kV in certain embodiments. In certain embodiments, a power cable can also meet the medium voltage electrical properties of Insulated Cable Engineers Association (“ICEA”) test standard S-94-649-2004.

In certain embodiments, a fire-retardant composition as disclosed herein can also advantageously be used as an outer layer of a solar cable. For example, advantageous solar cables can be formed of a cross-linked polyethylene (“XLPE”) inner layer and an outer layer formed of a fire-retardant composition as disclosed herein. Such solar cables can pass the requirements of both the United States and the European authorities to be used as solar cables including, for example, the UL 1581 VW-1 flame test, the LTIR requirements at 90° C. of UL 44 and the European Committee for Electrotechnical Standardization EN 50618 for Electric Cables for Photovoltaic Systems. EN 50618 subjects a cable to the test methods of EN 60216-1 and EN 60216-2 and describes an accelerated thermal aging test that determines the time required for a sample to reach a defined end point at various elevated temperatures. In EN 50618, linear plotting of test temperatures and times can be used to determine a single point characteristic known as the Temperature Index (“TI”) at which a material will reach a defined end point of 50% elongation at break after 20,000 hours. Solar cables including a fire-retardant composition as described herein can meet or exceed a Temperature Index of 120° C.

In certain embodiments, a solar cable including a fire-retardant composition as disclosed herein as an outer layer can pass the requisite standards to be used in the US and Europe despite being thinner than commercially available solar cables. For example, an 18 to 10 American Wire Gauge (“AWG”) solar cable including a 0.045 mil thick XLPE inner layer and a 0.03 mil thick outer layer formed of Example 14 or 15 of Table 2 can be used as a photovoltaic solar cable in the U.S. and Europe. A similar 8 AWG cable can be constructed with a 0.060 mil thick XLPE inner layer and a 0.030 mil thick outer layer formed of Example 14 or 15 of Table 2. The photovoltaic cables can be 2 kV cables.

### Examples

Tables 1 and 2 depict example compositions. Each of the compositions were molded into plaques to evaluate properties such as tensile strength and elongation at break. Additionally, 14 American Wire Gauge (“AWG”) cables were produced to evaluate qualifications relating to VW-1 flame test and LTIR requirements at 90° C. of UL 44. Table 1 illustrates Comparative Examples 1 to 8. Table 2 depicts Inventive Examples 9 to 16.

TABLE 1

| | Comp. | Comp. | Comp. | Comp. | Comp. | Comp. | Comp. | Comp. |
|---|---|---|---|---|---|---|---|---|
| Component | Ex. 1 | Ex. 2 | Ex. 3 | Ex. 4 | Ex. 5 | Ex. 6 | Ex. 7 | Ex. 8 |
| Ethylene Vinyl | 100 | 90 | — | — | 90 | 90 | 90 | 90 |
| Acetate, 28% VA | | | | | | | | |
| Ethylene Vinyl | — | — | — | — | — | — | — | — |
| Acetate, 40% VA | | | | | | | | |
| Metallocene | — | — | 90 | 90 | — | — | — | — |
| Catalyzed | | | | | | | | |
| Polyolefin | | | | | | | | |
| Anhydride | — | 10 | 10 | 10 | 10 | 10 | 10 | 10 |
| modified | | | | | | | | |
| polyethylene | | | | | | | | |
| Antimony | — | 10 | — | 10 | 10 | 10 | 10 | 10 |
| Trioxide | | | | | | | | |
| Magnesium | 175 | 160 | 155 | 155 | 165 | 160 | 155 | 160 |
| Hydroxide | | | | | | | | |
| Clay | 10 | — | 30 | 20 | 10 | — | — | — |
| Zinc Borate | — | 5 | — | — | — | 5 | 5 | 5 |
| Vinyl | 6.6 | 6.6 | 6.6 | 6.6 | 6.6 | 6.6 | 6.6 | 6.6 |
| Oligomeric | | | | | | | | |
| Silane | | | | | | | | |
| Antioxidants | 1.5 | 0-3 | 0-3 | 0-3 | 0-3 | 0-3 | 0-3 | 0-3 |
| Toluimidazole | 3 | — | — | — | — | — | — | — |
| Lubricant | 2 | 1 | 2 | 2 | 2~4 | 2 | 2 | 2 |
| Polybutadiene | 6 | 6 | 6 | 6 | 6 | 6 | 6 | 6 |
| Styrene | | | | | | | | |
| Copolymer | | | | | | | | |
| Color | 5 | 5 | 5 | 5 | 5 | 5 | 5 | 5 |
| concentrate | | | | | | | | |
| Peroxide | 2.3 | 2.3 | 2.3 | 2.3 | 2.3 | 2.3 | 2.3 | 2.3 |
| Total | 311.4 | 295.9 | 306.9 | 306.9 | 304.9 | 296.9 | 291.9 | 296.9 |
| Properties | | | | | | | | |
| VW-1 at 14 | Fail | Fail | Fail | Fail | Fail | Fail | Fail | Pass |
| AWG, 30 mil | | | | | | | | |
| insulation | | | | | | | | |
| Tensile | 2331 | 2700 | >2000 | >2000 | >2000 | >2000 | >2000 | >2000 |
| Strength (PSI) | | | | | | | | |
| Elongation at | 126 | 180 | >150 | >150 | <150 | >150 | >150 | >150 |
| Break (%) | | | | | | | | |
| LTIR UL 44 at | — | Pass | — | — | — | — | — | — |
| 90° C. in water | | | | | | | | |

Comparative Examples 1 to 7 are comparative because each Example fails the requirements of the VW-1 flame test. Comparative Example 8 is comparative because it includes an oxygen-free anhydride modified polyethylene.

TABLE 2

| | Inv. | Inv. | Inv. | Inv. | Inv. | Inv. | Inv. | Inv. |
|---|---|---|---|---|---|---|---|---|
| Component | Ex. 9 | Ex. 10 | Ex. 11 | Ex. 12 | Ex. 13 | Ex. 14 | Ex. 15 | Ex. 16 |
| Ethylene Vinyl | 100 | 100 | 100 | 90 | 100 | 100 | — | 100 |
| Acetate, 28% VA | | | | | | | | |
| Ethylene Vinyl | — | — | — | 10 | — | — | — | — |
| Acetate, 40% VA | | | | | | | | |
| Ethylene Vinyl | — | — | — | — | — | — | 100 | — |
| Acetate, 18% VA | | | | | | | | |
| Antimony | 10 | 10 | 20 | 20 | 10 | 10 | 10 | 14 |
| Trioxide | | | | | | | | |
| Magnesium | 165 | 165 | 165 | 165 | 160 | 160 | 173 | 165 |
| Hydroxide | | | | | | | | |
| Clay | 10 | 10 | — | — | — | — | — | — |
| Zinc Borate | — | — | — | — | 5 | 5 | 4 | — |
| Melamine | — | — | — | — | — | — | — | 20 |
| Compound | | | | | | | | |
| Vinyl | 6.6 | 6.6 | 6.6 | 6.6 | 6.6 | 6.6 | 3 | 3 |
| Oligomeric | | | | | | | | |
| Silane | | | | | | | | |
| Antioxidants | 1.5 | 0-3 | 0-3 | 0-3 | 0-3 | 0-3 | 0-3 | 0-3 |
| Toluimidazole | 3 | — | — | — | — | — | — | — |
| Lubricant | 2 | 2 | 2 | 2 | 2 | 1 | 1 | 1 |
| Polybutadiene | 6 | 6 | 6 | 6 | 6 | 6 | 6 | 6 |
| Styrene | | | | | | | | |
| Copolymer | | | | | | | | |
| Color | 5 | 5 | 5 | 5 | 5 | 5 | 5 | 4 |
| concentrate | | | | | | | | |
| Peroxide | 2.3 | 2.3 | 2.3 | 2.3 | 2.3 | 2.3 | 2.3 | 3.3 |
| Total | 311.4 | 306.9 | 306.9 | 306.9 | 296.9 | 295.9 | 304.3 | 316.3 |
| Properties | | | | | | | | |
| VW-1 at 14 | Pass | Pass | Pass | Pass | Pass | Pass | Pass | Pass |
| AWG, 30 mil | | | | | | | | |
| insulation | | | | | | | | |
| Tensile | 2326 | >2000 | >2000 | >2000 | >2000 | 2400 | 2600 | 1890 |
| Strength (PSI) | | | | | | | | |
| Elongation at | 150 | >150 | >150 | >150 | >150 | 210 | 180 | 197 |
| Break (%) | | | | | | | | |
| LTIR UL 44 at | — | — | — | — | — | Pass¹ | Pass² | Pass¹ |
| 90° C. in water | | | | | | | | |

¹Passes 2 weeks of testing
²Passes 16 weeks of testing

Inventive Examples 9 to 16 each include an oxygen-containing base polymer, a primary filler, and a secondary filler. Additionally, each of the Inventive Examples 9 to 15 exhibits an elongation at break of 150% or more, and pass the requirements of the UL 1581 VW-1 flame test.

Examples 14 to 16 were further evaluated to determine if they passed the LTIR requirements at 90° C. of UL 44. The LTIR UL 44 tests for Examples 14 to 16 were performed at 90° C. for 16 weeks. Examples 14 and 16 passed 2 weeks of testing before failure while Example 15 passed 16 weeks of testing.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent articles by those of ordinary skill in the art. Rather it is hereby intended the scope be defined by the claims appended hereto.

What is claimed is:

1. A cable comprising:
one or more conductors; and
a fire-retardant composition surrounding the one or more conductors, the fire-retardant composition comprising:
about 100 parts, by weight, of an oxygen-containing base polymer;
from about 80 parts to about 175 parts, by weight, of a primary filler, the primary filler comprising a metal hydroxide; and
from about 5 parts to about 20 parts, by weight, of a secondary filler, the secondary filler comprising an antimony compound; and
wherein the fire-retardant composition is substantially halogen-free and exhibits an elongation at break of about 150% or more; and
wherein the cable passes the Underwriter's Laboratory (“UL”) 1581 VW-1 flame test.

2. The cable of claim 1, wherein the oxygen-containing base polymer comprises an ethylene vinyl acetate copolymer.

3. The cable of claim 1, wherein the ethylene vinyl acetate copolymer comprises about 28% to about 40%, or more, vinyl acetate.

4. The cable of claim 1, wherein the primary filler comprises magnesium hydroxide, aluminum hydroxide, or a combination thereof.

5. The cable of claim 1, wherein the fire-retardant composition comprises from about 10 parts to about 15 parts, by weight, of the secondary filler.

6. The cable of claim 1, wherein the antimony compound is antimony trioxide.

7. The cable of claim 1, wherein the fire-retardant composition further comprises from about 3 parts to about 10 parts, by weight, of a polybutadiene styrene copolymer.

8. The cable of claim 1, wherein the fire-retardant composition further comprises from about 3 parts to about 25 parts, by weight, of a flame retardant synergist, the flame retardant synergist selected from the group consisting of zinc borate, zinc stannate, basic zinc molybdate, zinc calcium molybdate, zinc sulfide, hydrated structured silicates, synthetic anionic hydrotalcite, a clay mineral, talc, mica, kaolin, zeolites, expandable graphites, melamine compounds, phosphorus compounds, boron compounds, silicone compounds, and combinations thereof.

9. The cable of claim 1, wherein the fire-retardant composition is cross-linked.

10. The cable of claim 1, wherein the fire-retardant composition further comprises one or more of an antioxidant and a lubricant comprising one or more of an ultra-low molecular weight polyethylene, a fatty acid, and an olefinic oligomer.

11. The cable of claim 1, wherein the fire-retardant composition further comprises from about 4 parts to about 10 parts, by weight, of a vinyl oligomeric silane surface treatment agent.

12. The cable of claim 1, wherein the fire-retardant composition comprises about 5 parts or less, by weight, of an oxygen-free polyolefin.

13. The cable of claim 1, wherein the fire-retardant composition is substantially free of aluminum oxide.

14. The cable of claim 1 passes the Long Term Insulation Resistance (“LTIR”) requirements at 90° C. in accordance to UL 44.

15. The cable of claim 1 further comprising a halogen-free layer disposed between the one or more conductors and the fire-retardant composition.

16. A cable comprising:
one or more conductors; and
a fire-retardant composition surrounding the one or more conductors, the fire-retardant composition comprising:
about 100 parts, by weight, of an oxygen-containing base polymer;
from about 80 parts to about 175 parts, by weight, of a primary filler, the primary filler comprising a metal hydroxide; and
from about 5 parts to about 20 parts, by weight, of a secondary filler, the secondary filler comprising an antimony compound; and
wherein the fire-retardant composition is substantially halogen-free and exhibits an elongation at break of about 150% or more; and
wherein the cable passes the Underwriter's Laboratory (“UL”) 1581 VW-1 flame test and the Long Term Insulation Resistance (“LTIR”) requirements at 90° C. in accordance to UL 44.

17. A cable comprising:
one or more conductors;
an inner layer surrounding the one or more conductors and comprising a halogen-free composition; and
an outer layer surrounding the inner layer and comprising a fire-retardant composition; and
wherein the fire-retardant composition comprises:
about 100 parts by weight of an oxygen-containing base polymer;
from about 80 parts to about 175 parts by weight of a primary filler comprising a metal hydroxide; and
from about 5 parts to about 20 parts by weight of a secondary filler comprising an antimony compound; and
wherein the halogen-free composition comprises one or more of a polyolefin and an ethylene propylene rubber; and
wherein the cable passes the Underwriter's Laboratory (“UL”) 1581 VW-1 flame test, the Long Term Insulation Resistance (“LTIR”) requirements at 90° C. in accordance to UL 44, and the European Committee for Electrotechnical Standardization (“CENELEC”) EN 50618.

18. The cable of claim 17 wherein the inner layer has a thickness of about 0.045 mil and the outer layer has a thickness of about 0.075 mil.

19. The cable of claim 17 wherein the polyolefin is cross-linked polyethylene (“XLPE”) and the ethylene propylene rubber is a filled ethylene propylene rubber.

20. The cable of claim 17 is a photovoltaic cable.
